(19) United States
(12) Patent Application Publication
(10) Pub. No.: US 2013/0032039 A1
(43) Pub. Date: Feb. 7, 2013

(54) Heat resistant non-stick modular strip separator accessory for cooking, baking and other applications

(71) Applicant: Mihai Andrei Mazilu, Tustin, CA (US)

(72) Inventor: Mihai Andrei Mazilu, Tustin, CA (US)

(21) Appl. No.: 13/136,432

(22) Filed: Aug. 1, 2011

(51) Int. Cl. A47J 43/18

(52) U.S. Cl. 99/426

(57) ABSTRACT

The invention is a cooking/baking accessory that aids in cooking multiple types of different ingredients/items without having them mix and/or without having the flavors mix. Specifically, the accessory is a modular strip, made out of heat resistant non-stick material or materials, which can be used in one piece or combined with other identical modules to physically divide the cooking/baking area into separate smaller ones. The modularity is achieved by using a rectangular slit on the top side, a connector on one of the vertical edges and a hole on of the same shape as the connector on the other vertical edge.

### CROSS REFERENCE TO RELATED APPLICATIONS

Patent No. 2006/0278097—Daniel Piccirilli—Griddle with Multiple Cooking Areas—Published Dec. 14, 2006, is also a kitchen accessory to be placed on top of a griddle, that would also allow it to have multiple cooking areas. These areas are not separated by anything, but rather are part of the same cooking surface; the functionality is created by having enough space in between the cooking surfaces. The present invention is different in design as it is a separating accessory, not an accessory to be cooked on. Also, it can be used on any type of flat cooking surface and also allows for actual separation of the ingredients/items while at the same time being modular.

Patent No. US 2011/0067581—Daniel Janocha—Griddle Top Having Grooves for Fat Drainage—Published Mar. 24, 2011, is an accessory that has the same basic functionality (it can be placed on another flat cooking surface), but unlike the present invention, it is another cooking surface with built-in grooves that can only handle certain shapes of the ingredients. The present invention is different in design as it is a separating accessory, not an accessory to be cooked on.

### STATEMENT REGARDING FEDERALLY SPONSORED RESEARCH OR DEVELOPMENT

Not Applicable

### BACKGROUND OF THE INVENTION

The present invention relates generally to food preparation accessories and more particularly, to a modular heat resistant non-stick strip used to separate ingredients or items during the cooking or the baking process on a flat surface—pan, griddle, hotplate or other devices with similar functionality.

The main issue with the cooking devices with a flat surface (pans, griddles, hotplates and other devices with similar functionality) is that they only have one cooking area for heating the food items, thus potentially causing a mixing of the ingredients/items being cooked or baked and also a mixing of the flavors. While this is desirable for certain dishes, it limits the use of the cooking surface/area to items that are to be eaten together or to similar items where the mixing of flavors and/or ingredients/items either enhances the final product or it is irrelevant to the final product. It would be desirable to either have the ingredients separated so that they and their flavors would not mix, but could still be cooked together on the same surface at the same time. An added benefit of having multiple areas on the same cooking surface (be it pan, griddle, hot plate or other device with similar functionality) would be the possibility to cook very different foods at the same time without contaminating one another.

### BRIEF SUMMARY OF THE INVENTION

The invention is a modular separator accessory to be placed (either in one piece or in combined modules) in the pan or griddle, thereby allowing the division of the cooking/baking surface and the separation of various ingredients/items being cooked/baked, so that they do not mix and the flavors stay separated too.

The cooking surface gets heated, and then the invention either in one piece or in a pattern made out of more modules gets placed onto the surface in order to divide it into to the desired areas. The ingredients/items are placed and/or the cooking liquids are added. The current invention will seal the different compartments/areas of the cooking surface, thus preventing those liquids as well as the items/ingredients from mixing. It will help preserve the taste, integrity as well as esthetics of the dishes being cooked.

The invention will therefore be best suited for home cooks that wish to cook/bake multiple different dishes at the same time, campers, tailgaters, and also for restaurant and professional kitchens.

### BRIEF DESCRIPTION OF THE SEVERAL VIEWS OF THE DRAWING

The features of the invention will be more fully understood by references to the following drawings:

FIG. 1 is a perspective view of the heat resistant non-stick modular strip separator module

FIG. 2 is a front view of the heat resistant non-stick modular strip separator module

FIG. 3 is a top view of the heat resistant non-stick modular strip separator module

FIG. 4 is a left side view of the heat resistant non-stick modular strip separator module

FIG. 5 is a right side view of the heat resistant non-stick modular strip separator module

FIG. 6 is an exploded view of three heat resistant non-stick modular strip separator modules, showing how they can be combined either in line or in a cross pattern

FIG. 7 is a perspective view of the heat resistant non-stick modular strip separator demonstrating how the modules can be assembled both in line or in a cross pattern

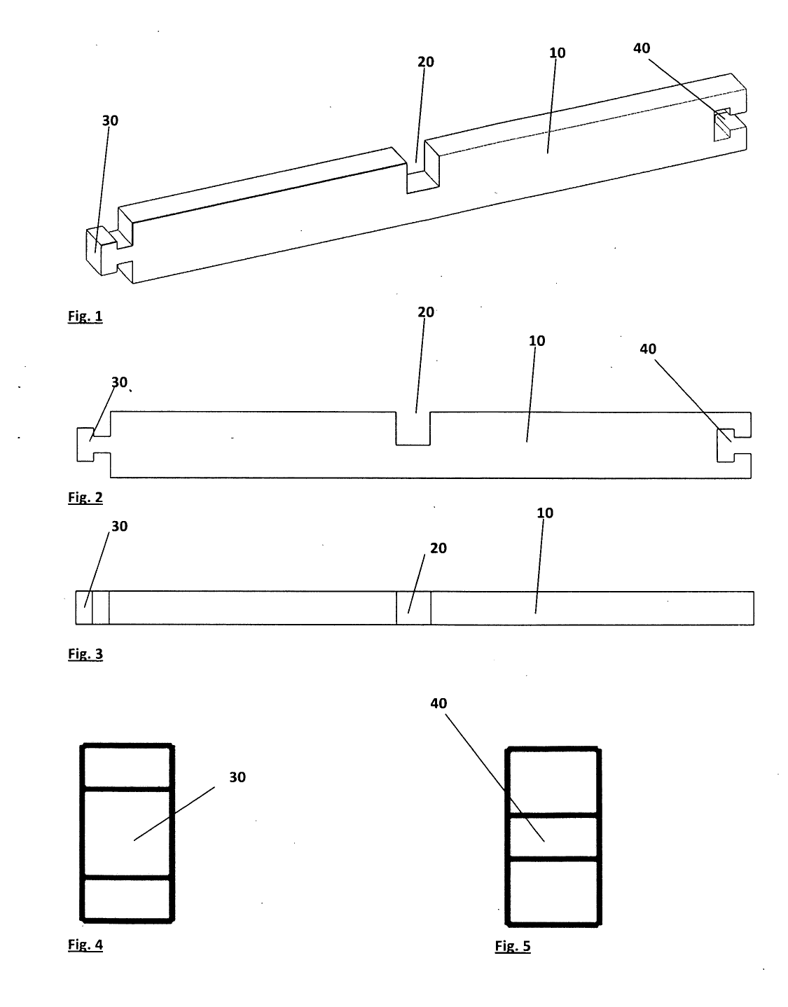

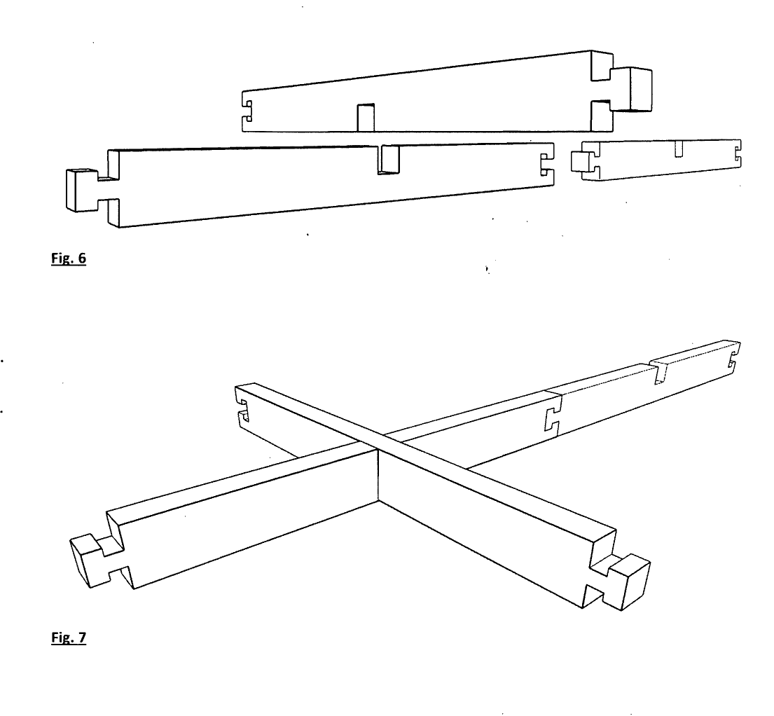

The figures referenced above include the following components:

10 The entire strip represents a module, the main functional element of the heat resistant non-stick modular strip separator

20 The rectangular slit in the middle of the top horizontal portion of the invention (used to connect with the same component 20 of another module). Its length should be equal to the thickness of the module and its height should be half the height of the module.

30 The left side connector to be used to connect with other modules in line. Its shape should be symmetrical on the horizontal axis of the module

40 The right side hole to be used to connect with other modules in line (component 30 of the connecting module would fit in this hole)

### DETAILED DESCRIPTION OF THE INVENTION

The main component of the heat resistant non-stick modular strip separator is the module in FIG. 1, also corresponding to component 10 in the drawings. The module is one basic element that can either used alone or can be combined with other identical modules either in line or in a cross pattern to allow for any desired shape, thus allowing the users to customize the invention as required by their needs.

The heat resistant modular strip separator modules have a very simple design and as a result are very easy and cheap to manufacture, distribute and use. The modularity allows it a wide variety of uses: cooking, baking as well as other similar culinary and foreseeable industrial applications. It can be manufactured out of any heat resistant and/or non-stick material and it can also be covered in any material as required by the desired specific application.

The module can be made out of or covered with a heat resistant and non-stick material so that it can resist the high temperatures associated with cooking/baking. The module will have a rectangular slot (with its length equal to the thickness of the strip and its height equal to up to half the height of the strip) in the middle edge of the horizontal side (component 20 in the drawings) to allow for the components to be connected into a cross pattern (as shown in FIG. 7), and with a tongue on a first end (component 30) and a receiving slot located on the opposite end. (Component 40) cut into the opposite vertical side to allow for the components to be connected in line (as shown in FIG. 7).The shape of the inner portion of the receiving slot may be complimentary in shape to the outer portion of the tongue.

FIG. 6 shows an exploded view of how the modules of the heat resistant non-stick modular strip separator can be combined either into a cross pattern or in an inline pattern.

As it can be seen from FIG. 6, the modules can be combined in a cross pattern, by inserting Component 20 of a module into the Component 20 of another module (one of the modules will be upside down), until the top side and the bottom side of each module are aligned with the bottom side and the top side of the other module.

As it can be seen from FIG. 6, the modules can be combined in a line pattern, by inserting Component 30 of a module into the Component 40 of another module, until the front side and the back side of each module are aligned with the front and the back side of the other module.

The heat resistant non-stick modular strip separator module or any other pattern made of the same modules will placed on the flat cooking surface, be it inside a pan, griddle hotplate or any other flat surface or device with similar functionality. Thus the cooking/baking surface will be divided in multiple areas. It will allow for the various ingredients/items to be placed and cooked/baked separately with little worries about mixing in the ingredients and/or flavors. Once, the cooking/baking is finalized the pattern will be removed.

What is claimed is:

1. A heat resistant non-stick separating device comprising of :
An elongated member having a first end and a second end;
A slit on the top side with the length of the slit approximately equal to the thickness of the strip and the height equal to up to half of the height of the strip
An outside connector on one of the vertical edges of the strip, that is of a shape that is symmetrical on the horizontal axis of the strip
A hole on the other vertical edge of the strip, of the same shape as the connector on the other vertical side
A heat resistant material, either in its entirety or just as cover
A non-stick material, either in its entirety or just as cover

2. The heat resistant non-stick modular strip separator according to claim 1, wherein said plurality of modules may be connected to each other to form either a cross or in line pattern. The modular strips can be fitted in a cross pattern when adjoined together in the middle using the rectangular slits or they can be joined in line by fitting the connector on one vertical side in the hole on the vertical side of the other module.

3. The heat resistant non-stick modular strip separator according to claim 1, either in one module or a combination thereof is to be placed on any flat cooking/baking surface thus dividing it into separate cooking/baking areas.
